(19) United States
(12) Patent Application Publication
(10) Pub. No.: US 2021/0171119 A1
(43) Pub. Date: Jun. 10, 2021

(54) VEHICLE BODY STRUCTURE

(71) Applicants: TOYOTA JIDOSHA KABUSHIKI KAISHA, Aichi-ken (JP); SUBARU CORPORATION, Tokyo (JP)

(72) Inventors: Yusuke SUGIURA, Aichi-ken (JP); Kazunori MASAOKA, Toyota-shi (JP)

(21) Appl. No.: 17/082,012

(22) Filed: Oct. 28, 2020

(30) Foreign Application Priority Data
Dec. 5, 2019 (JP) 2019-220643

(51) Int. Cl. B62D 25/14; B60K 1/04; B62D 1/20; B62D 25/20

(52) U.S. Cl. CPC B62D 25/145; B60K 1/04; B60K 2001/0438; B62D 25/2045; B62D 1/20

(57) ABSTRACT

The disclosure herein provides a technique for protecting a power source arranged under a floor panel against rearward movement of an intermediate shall upon a frontal collision to a vehicle. A vehicle body structure may include: a dash panel; a floor panel connected to a lower part of the dash panel; a power source arranged under the floor panel; a dash crossmember arranged at the lower part of the dash panel and extending along a vehicle lateral direction; and an intermediate shaft penetrating the dash panel and passing forward of the dash crossmember. An upper end of the intermediate shaft may be connected to a steering column shall and a lower end of the intermediate shaft may be connected to an input shaft of a steering gear unit. The intermediate shaft may include a weak portion.

### CROSS-REFERENCE TO RELATED APPLICATION

This application claims priority to Japanese Patent Application No. 2019-220643 filed on Dec. 5, 2019, the contents of which are hereby incorporated by reference into the present application.

### TECHNICAL FIELD

The technique disclosed herein relates to a vehicle body structure. The technique particularly relates to a vehicle body structure that protects a power source arranged under a floor panel against impact of a frontal collision to the vehicle.

### BACKGROUND

Japanese Patent Application Publication No. 2019-18732 describes an electric vehicle in which a power source (battery pack) is arranged under a floor panel. A front end of the floor panel is connected to a lower end of a dash panel. To enhance the strength of a part of the vehicle body that is located forward of the power source, a dash crossmember is attached to a boundary between the dash panel and the floor panel. The dash panel, the floor panel, and the dash crossmember define a pipe that extends along a vehicle lateral direction and has a closed cross section orthogonal to the vehicle lateral direction. The pipe extending along the vehicle lateral direction enhances the strength of the part of vehicle body that is located forward of the power source.

### SUMMARY

An intermediate shaft is located forward of the dash panel. The intermediate shaft penetrates the dash panel. A lower end of the intermediate shaft is connected to an input shaft of a steering gear and an upper end of the intermediate shaft is connected to a steering column shaft (steering main shaft). Upon a frontal collision to the vehicle, the intermediate shaft moves rearward and contacts the dash panel. If this contact force is large, the above-described crossmember may thereby be deformed and contact the power source. The disclosure herein provides a technique for protecting a power source arranged under a floor panel against rearward movement of an intermediate shaft upon a frontal collision to a vehicle.

A vehicle body structure disclosed herein may comprise a dash panel, a floor panel, a power source, a dash crossmember, and an intermediate shaft. The dash panel may separate a front compartment of a vehicle from a cabin of the vehicle. The floor panel may be connected to a lower part of the dash panel. The power source may be arranged under the floor panel. The dash crossmember may be arranged at the lower part of the dash panel and extending along a vehicle lateral direction. The intermediate shaft may penetrate the dash panel and pass forward of the dash crossmember. An upper end of the intermediate shaft may be connected to a steering column shaft and a lower end of the intermediate shaft may be connected to an input shaft of a steering gear unit. The intermediate shaft may include a weak portion.

In the vehicle body structure disclosed herein, the intermediate shaft includes the weak portion. The weak portion allows the intermediate shaft to fracture at the weak portion when the intermediate shaft contacts the dash panel. This mitigates impact on the dash panel and the dash crossmember, and thus mitigates impact transferred to the power source. The weak portion may typically be a groove disposed in an outer surface of the intermediate shaft. Moreover, the weak portion may be located forward of the dash crossmember.

Details and further improvements of the technique disclosed herein will be described in Detailed Description below.

### BRIEF DESCRIPTION OF DRAWINGS

FIG. 1 is a perspective view of a vehicle body (around a steering main shaft).

FIG. 2 shows a lower part of an intermediate shaft.

FIG. 3 is a cross-sectional view of a dash panel and a dash crossmember.

FIG. 4 is a cross-sectional view of the dash panel and the dash crossmember (upon a collision).

FIG. 5 shows the dash panel when viewed obliquely from the rear.

### DETAILED DESCRIPTION

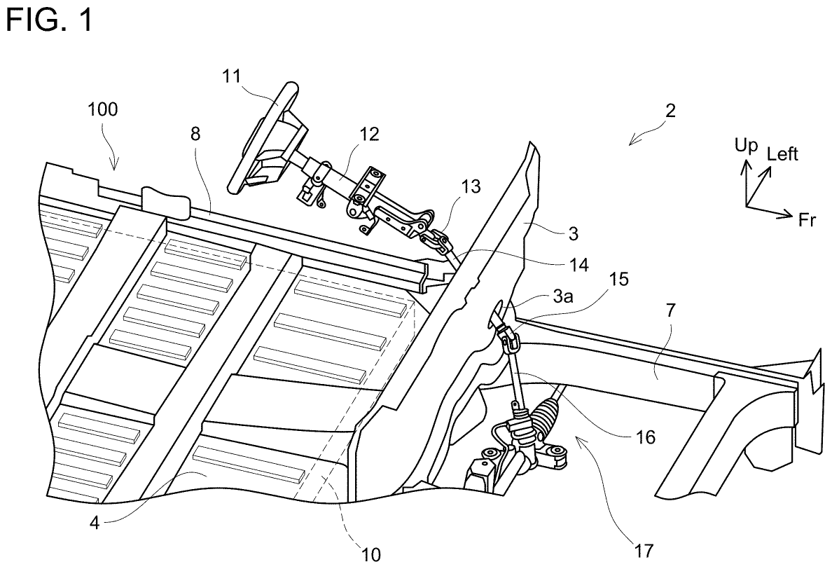

With reference to the drawings, a vehicle body structure 2 of an embodiment will be described. FIG. 1 shows a perspective view of a vehicle body 100. In the coordinate system in FIG. 1, “Fr” indicates a front direction of the vehicle, “Up” indicates an up direction of the vehicle, and “Left” indicates a left direction when the vehicle is viewed from its rear toward its front. The same applies to the “Left” in coordinate systems in the other drawings.

The vehicle body 100 includes a dash panel 3, a floor panel 4, a pair of side members 7, and a pair of rockers 8. FIG. 1 does not show one of the pair of side members 7 and one of the pair of rockers 8. The dash panel 3 is a partition that separates a front compartment of the vehicle from a cabin of the vehicle. Edges of the dash panel 3 in a vehicle lateral direction are respectively connected to the side members 7 and are respectively connected to the rockers 8. Moreover, a lower end of the dash panel 3 is connected to a front end of the floor panel 4.

The vehicle body 100 is a body of an electric vehicle. In the vehicle body 100, a battery pack 10 configured to supply electric power for a traction motor is arranged under the floor panel 4.

A steering column shaft 12 is connected to a steering 11. The steering column shaft 12 is supported by the dash panel 3 via a bracket (not shown). A front end of the steering column shaft 12 is connected to an upper end of an intermediate shaft 14 via a universal joint 13. The intermediate shaft 14 penetrates the dash panel 3 through a hole 3a provided in the dash panel 3 and reaches the front compartment. The intermediate shaft 14 extends along an up-down direction. A lower end of the intermediate shaft 14 is connected to a steering gear unit 17. More specifically, the lower end of the intermediate shall 14 is connected to an input shaft 16 of the steering gear unit 17 via a universal joint 15.

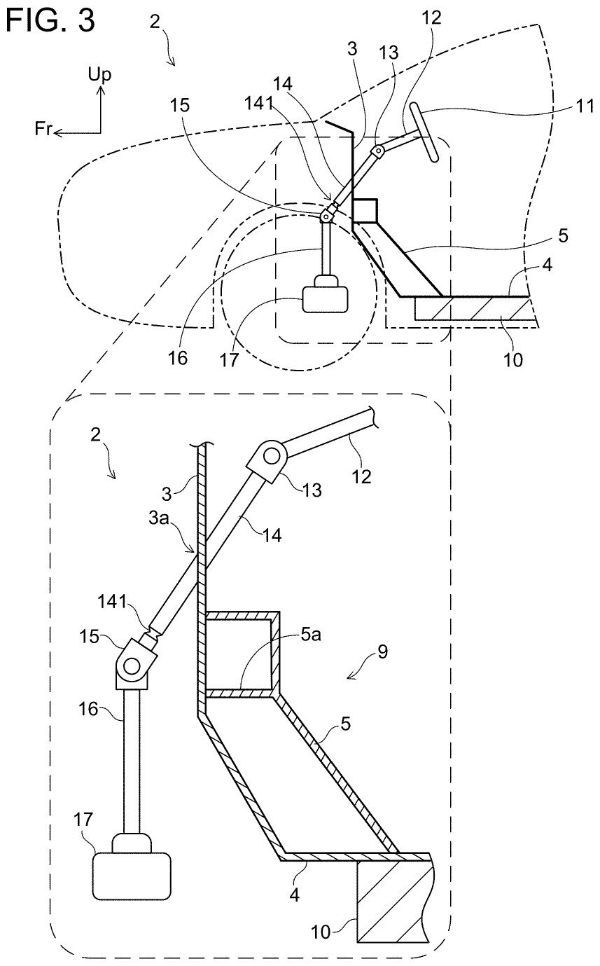

A dash crossmember 5 is disposed at a boundary between the dash panel 3 and the floor panel 4, which will be illustrated in FIG. 3 in detail.

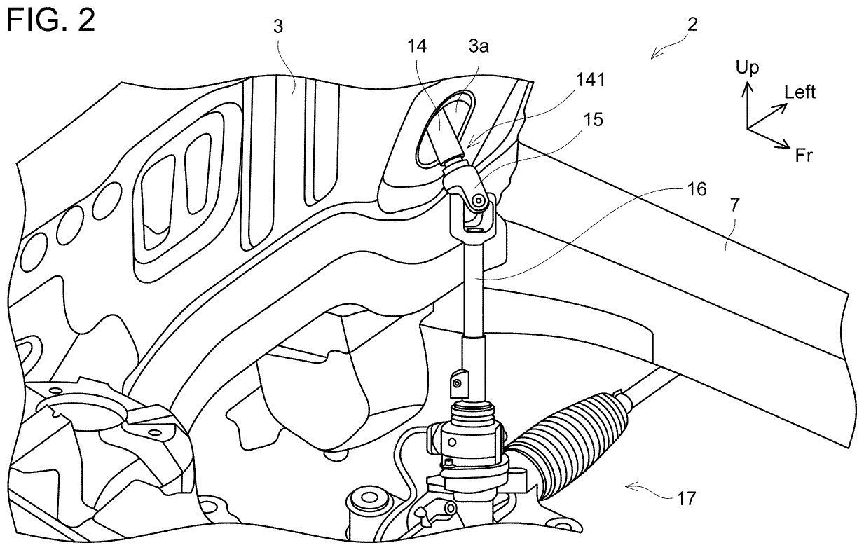

FIG. 2 shows the lower end of the intermediate shaft 14 and its surroundings. As described above, the lower end of the intermediate shaft 14 is connected to the input shaft 16 of the steering gear unit 17 via the universal joint 15. The intermediate shaft 14 includes a groove 141 in its lower portion near the universal joint 15. The groove 141 entirely extends along an outer surface of the intermediate shaft 14.

FIG. 3 shows a cross-sectional view of the dash panel 3 and the dash crossmember 5. FIG. 3 shows a cross section obtained by cutting the dash panel 3 and the dash crossmember 5 along a plane orthogonal to the vehicle lateral direction. FIG. 3 shows the contour of the vehicle by a phantom line. The upper diagram of FIG. 3 shows the dash panel 3 and the dash crossmember 5 in a thick line. The lower diagram of FIG. 3 shows an enlarged view of the intermediate shaft 14 and its surroundings.

The dash crossmember 5 is made of a thin plate. An upper end of the dash crossmember 5 is connected to the dash panel 3 and a lower end thereof is connected to the floor panel 4. In other words, the dash crossmember 5 is located at the boundary between the dash panel 3 and the floor panel 4. The dash panel 3, the floor panel 4, and the dash crossmember 5 define a hollow pipe 9 extending in the vehicle lateral direction. The pipe 9 improves the strength of the vehicle body at the boundary between the dash panel 3 and the floor panel 4. A rib 5a is arranged at the vicinity of a center of the dash crossmember 5 in the up-down direction. The rib 5a extends from the dash crossmember 5 toward the dash panel 3 which is located forward of the dash crossmember 5. A front end of the rib 5a is connected to the dash panel 3. The rib 5a enhances the strength of the pipe 9.

The battery pack 10 is arranged under the floor panel 4. The pipe 9 enhances the strength of the vehicle body at a lower part of the dash panel 3 (at the front end of the floor panel 4). The enhanced strength of the vehicle body provides favorable protection for the battery pack 10 upon a frontal collision to the vehicle. It should be noted that the intermediate shaft 14 passes forward of the dash crossmember 5 in the up-down direction, if the intermediate shaft 14 is moved rearward upon a frontal collision to the vehicle, the intermediate shaft 14 may contact the pipe 9 (the dash crossmember 5) and bend it. Although the pipe 9 protects the battery pack 10 against a frontal collision as described above, if the pipe 9 is bent rearward, the battery pack 10 may be damaged.

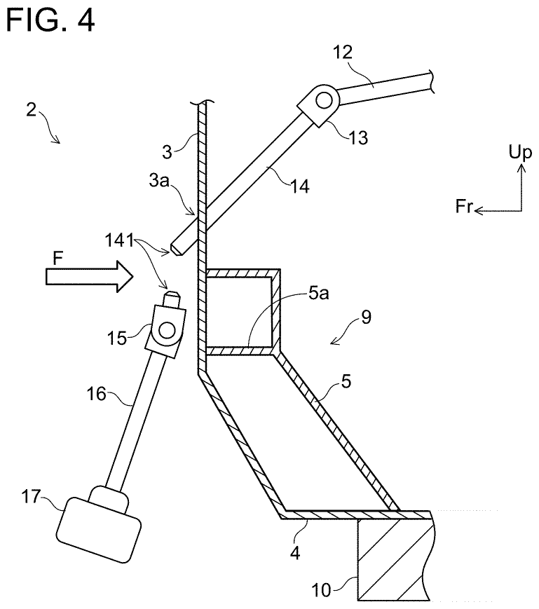

As described above, the intermediate shaft 14 includes, in its lower part, the groove 141 that entirely extends along the outer surface of the intermediate shaft 14. The groove 141 is located forward of the dash crossmember 5. The groove 141 locally decreases the strength of the intermediate shaft 14 in front of the dash crossmember 5. When the intermediate shaft 14 is moved rearward and contacts the pipe 9 upon a frontal collision, the intermediate shaft 14 breaks at the groove 141. FIG. 4 schematically shows the intermediate shaft 14 breaking under a collision load F applied from the front. Since the intermediate shaft 14 breaks when contacting the pipe 9, damage to the pipe 9 is mitigated, and thus damage to the battery pack 10 is also mitigated.

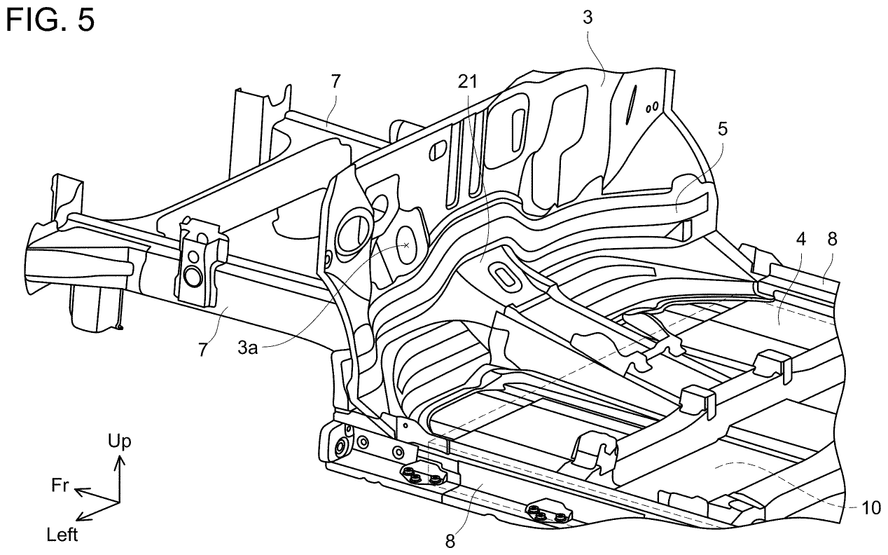

FIG. 5 shows a perspective view of the dash panel 3 when viewed obliquely from the rear. FIG. 5 depicts the battery pack 10, which is located under the floor panel 4, with a hidden line.

An upper edge of the dash crossmember 5 is connected to the dash panel 3 and an lower edge thereof is connected to the floor panel 4. The dash crossmember 5 extends in the vehicle lateral direction. In other words, the dash crossmember 5 is connected to the pair of rockers 8 between the rockers 8. Moreover, front ends of the rockers 8 are respectively connected to rear ends of the side members 7 via the dash panel 3. Lower parts of both ends of the dash panel 3 in the vehicle lateral direction are respectively connected to the rockers 8. Both ends of the floor panel 4 in the vehicle lateral direction are also respectively connected to the rockers 8.

Each of the dash panel 3 and the dash crossmember 5 is curved rearward from its center toward its ends in the vehicle lateral direction. In other words, when viewed from above, each of the dash panel 3 and the dash crossmember 5 has an arch shape with its ends located rearward of its center. The arch shapes of the dash panel 3 and the dash crossmember 5 also contribute to enhancement of the strength of the vehicle body. Moreover, a center tunnel 21 extending in the front-rear direction of the vehicle is disposed at a center of the floor panel 4 in the vehicle lateral direction. The center tunnel 21 also contributes to improvement in strength of the vehicle body.

The intermediate shaft 14, which is not shown in FIG. 5, penetrates the dash panel 3 through the hole 3a of the dash panel 3.

Points to be noted regarding the technique described in the embodiment will be listed. The groove 141, which is disposed in the lower part of the intermediate shall 14, is provided to allow the intermediate shaft 14 to break when the intermediate shaft 14 contacts the dash panel 3. In other words, the groove 141 is a weak portion. The weak portion is not limited to the groove 141 and may be any structure as long as it can locally decrease the strength of the intermediate shaft 14. For example, the weak portion may be a hole provided in the intermediate shaft 14.

The battery pack 10 corresponds to an example of a power source mounted on the vehicle. The technique disclosed herein is also suitably applied to electric vehicles in which fuel cells are arranged under the floor panel.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A vehicle body structure comprising:
a dash panel separating a front compartment of a vehicle from a cabin of the vehicle;
a floor panel connected to a lower part of the dash panel;
a power source arranged under the floor panel;
a dash crossmember arranged at the lower part of the dash panel and extending along a vehicle lateral direction; and
an intermediate shaft penetrating the dash panel and passing forward of the dash crossmember, wherein an upper end of the intermediate shall is connected to a steering column shaft and a lower end of the intermediate shaft is connected to an input shaft of a steering gear unit,
wherein the intermediate shaft includes a weak portion.

2. The vehicle body structure of claim 1, wherein the weak portion includes a groove disposed in an outer surface of the intermediate shaft.

3. The vehicle body structure of claim 2, wherein the groove entirely extends along the outer surface of the intermediate shaft.

4. The vehicle body structure of claim 1, wherein the weak portion is located forward of the dash crossmember.
